(19) United States
(12) Patent Application Publication
(10) Pub. No.: US 2025/0346522 A1
(43) Pub. Date: Nov. 13, 2025

(54) GLASS PLATE AND PRODUCTION METHOD THEREFOR

(71) Applicant: Nippon Electric Glass Co., Ltd., Shiga (JP)

(72) Inventors: Kazuyoshi NAKAJIMA, Shiga (JP); Tsuyoshi OKUNO, Shiga (JP)

(21) Appl. No.: 18/861,680

(22) PCT Filed: May 24, 2023
(86) PCT No.: PCT/JP2023/019311

§ 371 Date: Oct. 30, 2024

(30) Foreign Application Priority Data
Jun. 7, 2022 (JP) 2022-092171

(51) Int. Cl. C03C 15/00; C03C 23/00; C09J 133/08

(52) U.S. Cl. CPC C03C 15/00; C03C 23/0025; C09J 133/08

(57) ABSTRACT

Provided is a method of manufacturing a glass sheet, the method including a processing step(S) of processing the glass sheet. The processing step(S) includes: a bonding step (S1) of bonding an adhesive film to one of main surfaces of the glass sheet to form a laminate; a modification step (S2) of forming a modified part in a preset processing part of the glass sheet in a state of the laminate by irradiation on the preset processing part with laser light; an etching step (S3) of etching the modified part of the glass sheet in the state of the laminate; and a peeling step (S5) of peeling off the adhesive film from the glass sheet.

### TECHNICAL FIELD

The present invention relates to a glass sheet and a method of manufacturing the glass sheet.

### BACKGROUND ART

A glass sheet having a fine through hole for interconnection (through-via or the like) is used as a substrate of, for example, a tiled display (micro LED or the like), a bezel-less display, or a glass interposer.

A processing step for this type of through hole includes, for example, a modification step of modifying a preset processing part for the through hole in the glass sheet by irradiation with laser light to form a modified part, and an etching step of etching the modified part to form a through hole (see, for example, Patent Literatures 1 and 2).

### CITATION LIST

Patent Literature 1: JP 2018-199605 A
Patent Literature 2: JP 2020-66551 A

### SUMMARY OF INVENTION

### Technical Problem

According to the above-mentioned processing step, the modified part formed in the modification step has an etching rate higher than that of a non-modified part, and is hence selectively removed in the etching step. Accordingly, when the modified part is formed in the preset processing part for the through hole, the through hole can be formed in the preset processing part by etching.

However, in the above-mentioned processing step, when the glass sheet is thin, it is difficult to handle the glass sheet, or the glass sheet warps during processing in some cases, which causes a problem in that processing is difficult. Such a problem is not limited to the case in which the through hole is formed in the glass sheet in the processing step, but may also arise similarly, for example, in a case in which a glass sheet having a predetermined shape is cut out from the glass sheet.

The present invention has an object to process a glass sheet easily and reliably even when the glass sheet is thin.

### Solution to Problem

(1) According to the present invention, there is provided a method of manufacturing a glass sheet, the method comprising a processing step of processing the glass sheet, the processing step comprising: a bonding step of bonding an adhesive film to one of main surfaces of the glass sheet to form a laminate; a modification step of forming a modified part in a preset processing part of the glass sheet in a state of the laminate by irradiation on the preset processing part with laser light after the bonding step; an etching step of etching the modified part of the glass sheet in the state of the laminate after the modification step; and a peeling step of peeling off the adhesive film from the glass sheet after the etching step.

With this configuration, rigidity of the glass sheet is improved by the adhesive film. Accordingly, in the modification step and the etching step, handleability of the glass sheet is improved, and warping of the glass sheet can be suppressed. Thus, the glass sheet can be easily and reliably processed even when the glass sheet is thin.

(2) In the configuration of the above-mentioned item (1), it is preferred that a thickness of the glass sheet in the bonding step be 1 μm or more and 100 μm or less.

When the glass sheet is thin as described above, the effect of the present invention becomes pronounced.

(3) In the configuration of the above-mentioned item (1) or (2), it is preferred that the laser light be ultrashort pulse laser light.

With this configuration, energy of the laser light is sufficiently high, and it becomes easier to form the modified part in the glass sheet.

(4) In the configuration of any one of the above-mentioned items (1) to (3), it is preferred that the laminate be immersed in an etchant in the etching step.

With this configuration, the modified part of the glass sheet can be etched efficiently. Even when the laminate is immersed in the etchant, of both front and back main surfaces of the glass sheet, one of the main surfaces of the glass sheet, to which the adhesive film is bonded, is not etched, and becomes a non-etched surface (for example, a fire-polished surface).

(5) In the configuration of any one of the above-mentioned items (1) to (4), it is preferred that the adhesive film comprise a polyolefin-based base material, and an acrylic-based or polyethylene-based adhesive layer formed on one surface of the base material.

With this configuration, appropriate rigidity is easily imparted to the laminate comprising the glass sheet and the adhesive film. Accordingly, in the modification step and the etching step, handleability of the glass sheet is further improved, and warping of the glass sheet can be more reliably suppressed. Further, chemical resistance of the adhesive film becomes satisfactory, and hence a reaction of the adhesive film in the etching step can be suppressed. In addition, peelability of the adhesive film becomes satisfactory, and hence the adhesive film can be easily peeled off from the glass sheet in the peeling step.

(6) In the configuration of any one of the above-mentioned items (1) to (5), it is preferred that a thickness of the adhesive film be 50 μm or more and 200 μm or less.

With this configuration, the adhesive film can be bent to an appropriate degree, and hence it becomes easier to peel off the adhesive film from the glass sheet in the peeling step.

(7) In the configuration of any one of the above-mentioned items (1) to (6), it is preferred that the method of manufacturing a glass sheet further comprise an adhesive strength weakening step of weakening adhesive strength of the adhesive film after the etching step and before the peeling step. Here, examples of the adhesive strength weakening step include irradiation with ultraviolet rays when the adhesive film contains an ultraviolet curable resin, and heating when the adhesive film contains a thermosetting resin.

With this configuration, in the modification step and the etching step, the adhesive strength of the adhesive film can be maintained at a strong level, and hence the glass sheet can be reliably reinforced with the adhesive film. Meanwhile, in the peeling step, the adhesive strength of the adhesive film can be weakened, and hence the adhesive film can be easily peeled off from the glass sheet.

(8) In the configuration of the above-mentioned item (7), it is preferred that the adhesive film have an adhesive strength of 0.5 N/20 mm or more before the adhesive strength weakening step, and an adhesive strength of less than 0.05 N/20 mm after the adhesive strength weakening step.

With this configuration, in the modification step and the etching step, the adhesive strength of the adhesive film can be at such an appropriately strong level as to prevent peeling. Meanwhile, in the peeling step, the adhesive strength of the adhesive film can be at such an appropriately weak level as to easily allow peeling.

(9) In the configuration of any one of the above-mentioned items (1) to (8), it is preferred that the adhesive film be larger than the glass sheet.

With this configuration, in the bonding step, it becomes easier to bond the adhesive film to the glass sheet. Further, in the modification step and the etching step, a protruding portion of the adhesive film protruding from the glass sheet can be supported, and hence handleability of the glass sheet becomes more satisfactory.

(10) According to the present invention, there is provided a glass sheet, comprising: a first main surface; a second main surface; and an end surface interposed between the first main surface and the second main surface, wherein the first main surface and the end surface are etched surfaces, wherein the second main surface is a fire-polished surface, and wherein a thickness between the first main surface and the second main surface is 1 μm or more and 100 μm or less.

With this configuration, the first main surface, the second main surface, and the end surface become smooth surfaces having satisfactory surface characteristics. Further, there are few defects such as cracks on the first main surface, the second main surface, and the end surface. As a result, even the thin glass sheet can achieve high strength. In particular, the second main surface is the fire-polished surface, and hence high smoothness can be achieved while reducing defects as much as possible.

(11) In the configuration of the above-mentioned item (10), it is preferred that surface roughness (Ra) of the second main surface be 0.2 nm or less.

With this configuration, the second main surface becomes a remarkably smooth surface.

(12) In the configuration of the above-mentioned item (10) or (11), the glass sheet may be a cover glass for a sensor or a cover glass for a hollow optical fiber.

The surface characteristics are satisfactory, and hence light scattering can be suppressed. Accordingly, the present invention can be suitably used as a cover glass for a sensor or a cover glass for a hollow optical fiber.

### Advantageous Effects of Invention

According to the present invention, the glass sheet can be processed easily and reliably even when the glass sheet is thin.

### BRIEF DESCRIPTION OF DRAWINGS

FIG. 1 is a flowchart for illustrating a processing step included in a method of manufacturing a glass sheet.

FIG. 2 is a plan view for illustrating a bonding step.

FIG. 3 is a sectional view taken along the line A-A of FIG. 2.

FIG. 4 is a plan view for illustrating a modification step.

FIG. 5 is a sectional view taken along the line B-B of FIG. 4.

FIG. 6 is a sectional view for illustrating an etching step.

FIG. 7 is a plan view for illustrating the etching step.

FIG. 8 is a sectional view taken along the line C-C of FIG. 7.

FIG. 9 is a sectional view for illustrating an adhesive strength weakening step.

FIG. 10 is a sectional view for illustrating a modification example of the adhesive strength weakening step.

FIG. 11 is a sectional view for illustrating a peeling step.

FIG. 12 is a plan view for illustrating the processed glass sheet.

FIG. 13 is a sectional view taken along the line D-D of FIG. 12.

### DESCRIPTION OF EMBODIMENTS

Embodiments of the present invention are described below with reference to the drawings.

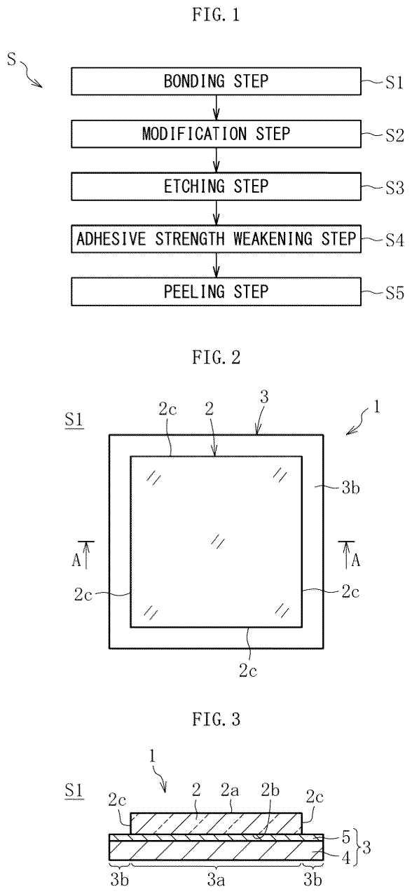

As illustrated in FIG. 1, a method of manufacturing a glass sheet according to this embodiment comprises a processing step S of cutting out a circular glass sheet from a rectangular glass sheet (original glass sheet before processing). The processing step S comprises a bonding step S1, a modification step S2, an etching step S3, an adhesive strength weakening step S4, and a peeling step S5 in the stated order. This manufacturing method may further comprise a forming step of forming the glass sheet (original glass sheet before processing) before the processing step S. In addition, this manufacturing method may further comprise a washing step of washing the processed glass sheet and an inspection step of inspecting the processed glass sheet after the processing step S.

### (Bonding Step)

As illustrated in FIG. 2 and FIG. 3, in the bonding step S1, a laminate 1 is formed. The laminate 1 is formed by bonding an adhesive film 3 to a glass sheet 2.

The glass sheet 2 comprises a first main surface 2a, a second main surface 2b, and end surfaces 2c interposed between the first main surface 2a and the second main surface 2b. The glass sheet 2 is formed using known forming methods including a down-draw method such as an overflow down-draw method or a slot down-draw method, and a float method. In this embodiment, the glass sheet 2 is formed by the overflow down-draw method. When the glass sheet 2 is formed by the overflow down-draw method, the first main surface 2a and the second main surface 2b become fire-polished surfaces. Here, the term “fire-polished surface” refers to an unpolished surface that has solidified without coming into contact with other components such as rollers after glass has melted. The fire-polished surface becomes a smooth surface with extremely few defects (for example, microcracks) that cause breakage. Surface roughness Ra of the fire-polished surface is, for example, 0.2 nm or less. Here, the surface roughness Ra means a value measured by a method conforming to JIS B0601: 2001.

An upper limit value of a thickness of the glass sheet 2 is preferably 10 μm, more preferably 50 μm. A lower limit value thereof is preferably 1 μm, more preferably 10 μm. In other words, it is preferred that the glass sheet 2 be an extremely thin glass film. The glass sheet 2 having a thickness of over 100 μm can be processed without bonding the adhesive film 3 to the glass sheet 2.

The adhesive film 3 is bonded only to the second main surface 2b of the glass sheet 2. The adhesive film 3 comprises a base material 4 and an adhesive layer 5 formed on one surface of the base material 4 (surface on the second main surface 2b side of the glass sheet 2). In a state of the laminate 1, the adhesive layer 5 is arranged between the glass sheet 2 and the base material 4. Thus, the glass sheet 2 is fixed to the base material 4 through intermediation of the adhesive layer 5.

As the base material 4, for example, a polyolefin-based resin (such as polyethylene or polypropylene) can be used. When the base material 4 of this material type is used, the base material 4 is likely to have chemical resistance (resistance to an etchant 12 (for example, HF) described below) and flexibility. The material of the base material 4 is not particularly limited as long as the base material 4 has chemical resistance.

As the adhesive layer 5, for example, an acrylic-based resin or a polyethylene-based resin can be used. When the adhesive layer 5 of this material type is used, the adhesive layer 5 is likely to have chemical resistance (resistance to the etchant 12 (for example, HF) described below). The material of the adhesive layer 5 is not particularly limited as long as the adhesive layer 5 has chemical resistance.

It is preferred that the adhesive layer 5 be a functional material whose adhesive strength changes between during fixation (modification step S2 and etching step S3) and during peeling (peeling step S5) due to predetermined treatment. Examples of the functional material that can change the adhesive strength include an ultraviolet curable resin that cures under irradiation with ultraviolet rays and a thermosetting resin that cures through heating. The adhesive film 3 may be a self-adhesive film that can be peeled off without undergoing predetermined treatment. In this case, the adhesive strength during fixation and the adhesive strength during peeling are substantially the same.

It is preferred that the adhesive strength during fixation be stronger than the adhesive strength during peeling. The adhesive strength during fixation is preferably 0.1 N/20 mm or more, more preferably 0.3 N/20 mm or more, still more preferably 0.5 N/20 mm or more. The adhesive strength during peeling is preferably 0.1 N/20 mm or less, more preferably 0.07 N/20 mm or less, still more preferably 0.05 N/20 mm or less. Here, the adhesive strength means a value measured by a method conforming to JIS Z 0237:2022.

It is preferred that the thickness of the adhesive film 3 (total thickness of the adhesive film 3 and the adhesive layer 5) be 50 μm u or more and 200 μm or less. With this configuration, the adhesive film 3 is likely to have appropriate rigidity and flexibility.

It is preferred that the adhesive film 3 be larger than the glass sheet 2 in plan view (when viewed along a thickness direction). In this embodiment, the adhesive film 3 protrudes outward from each end surface 2c of the glass sheet 2. In other words, the adhesive film 3 comprises a rectangular overlapping portion 3a that overlaps the glass sheet 2, and a rectangular protruding portion 3b that protrudes rectangular glass sheet 2. With this configuration, the glass sheet 2 can be handled while the protruding portion 3b is held, and thus workability in the processing step S becomes more satisfactory. Further, the glass sheet 2 is reinforced by the overlapping portion 3a, and hence it is possible to reliably prevent a situation in which the glass sheet 2 warps in the processing step S (particularly in the modification step S2). Accordingly, even when the glass sheet 2 is thin, the glass sheet 2 can be processed easily and reliably.

### (Modification Step)

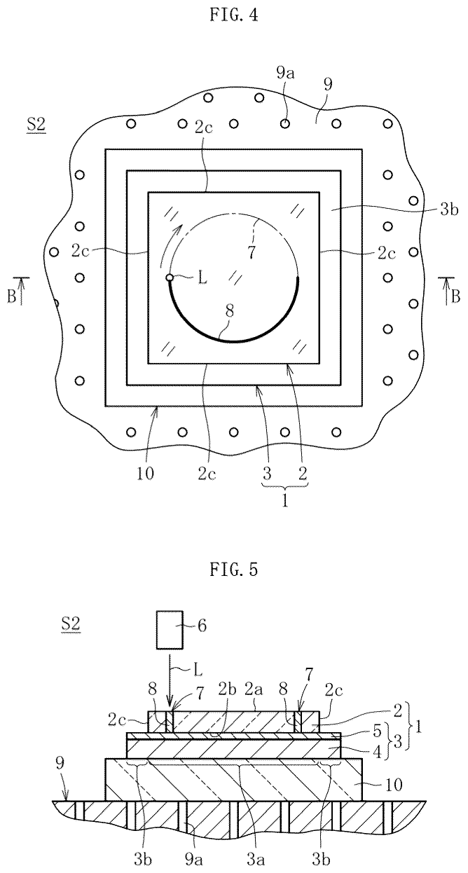

As illustrated in FIG. 4 and FIG. 5, the modification step S2 is performed on the laminate 1 in a state of comprising the glass sheet 2 and the adhesive film 3. In the modification step S2, a modified part 8 is formed in a preset processing part 7 of the glass sheet 2 included in the laminate 1 with laser light L radiated from a laser device 6. The modified part 8 has a property of being susceptible to etching and has an etching rate higher than that of a non-modified part. In this embodiment, the preset processing part 7 is a circularly shaped linear area for cutting out (hollowing out) a circular glass sheet. Accordingly, the laser light L is scanned in a circular pattern along the preset processing part 7. As a result, the modified part 8 is formed intermittently or continuously along the circularly shaped area in plan view. Further, the modified part 8 is formed intermittently or continuously along the thickness direction in side view (when viewed along a direction orthogonal to the thickness direction). From the viewpoint of improving processing accuracy, it is preferred that the modified part 8 be formed continuously in a circumferential direction and/or the thickness direction. The formation mode of the modified part 8 (for example, continuity or intermittency of the modified part 8) can be adjusted by, for example, a focal position, a spot diameter [mm], a spot spacing [mm], a pulse width [s], a repetition frequency [Hz], pulse energy [J], and peak power [W] of the laser light L.

The type and irradiation conditions of the laser light L are not particularly limited as long as the modified part 8 can be formed in the preset processing part 7. In this embodiment, the laser light L is ultrashort pulse laser light with a pulse width of picoseconds to femtoseconds.

In this embodiment, in the modification step S2, the laser light L is radiated onto the glass sheet 2 included in the laminate 1 under a state in which the laminate 1 adheres by suction to a suction-adhesion table 9 having a plurality of suction holes 9a. Specifically, in order to prevent the laminate 1 (in particular, the glass sheet 2) from deforming in accordance with the suction holes 9a, a support member 10 made of glass is arranged between the laminate 1 and the suction-adhesion table 9. It is preferred that the support member 10 be larger than the adhesive film 3 in plan view. Under this state, the glass sheet 2 is fixed to the adhesive film 3. The adhesive film 3 is held in close contact with a surface of the support member 10 by applying alcohol to the surface of the support member 10. The support member 10 is not limited to a glass sheet, and any member such as a metal sheet can be used as long as deformation of the laminate 1 during suction adhesion can be prevented. Further, when the glass sheet 2 included in the laminate 1 does not deform during suction adhesion, the support member 10 may not be provided.

### (Etching Step)

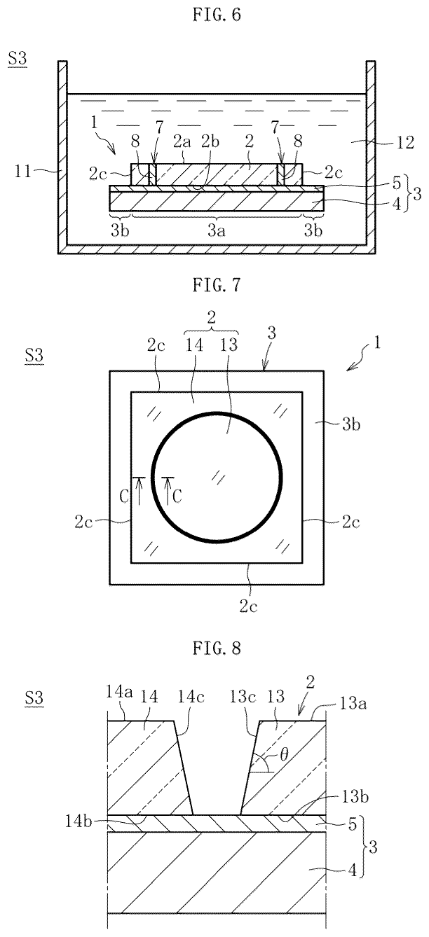

As illustrated in FIG. 6, the etching step S3 is performed on the laminate 1 in the state of comprising the glass sheet 2 and the adhesive film 3. In the etching step S3, the laminate 1 is immersed in the etchant 12 stored in an etching bath 11, and the modified part 8 of the glass sheet 2 is etched. In this case, the modified part 8 is etched preferentially, but the first main surface 2a and the end surfaces 2c, to which the adhesive film 3 is not bonded, are also etched at an etching rate lower than that of the modified part 8. In other words, the modified part 8 is removed by etching, and surface portions of the first main surface 2a and the end surfaces 2c are also slightly removed. Accordingly, the thickness of the glass sheet 2 is decreased by about a few percent to about 10% before and after etching. Specifically, for example, when the thickness of the glass sheet 2 is 50 μm before etching, the thickness is decreased to about 45 μm after etching.

A HF-based etchant or an alkali-based etchant may be used as the etchant 12. For example, a single acid formed of HF, or a mixed acid of at least one kind of acid selected from HCL, HNO₃, and H₂SO₄ and HF may be used as the HF-based etchant. For example, a NaOH aqueous solution or a KOH aqueous solution may be used as the alkali-based etchant.

The etching of the modified part 8 of the glass sheet 2 is advanced from the first main surface 2a side, to which the adhesive film 3 is not bonded. Accordingly, in the modified part 8, an etching removal amount on the first main surface 2a side tends to be larger than an etching removal amount on the second main surface 2b side. As a result, as illustrated in FIG. 7 and FIG. 8, when the modified part 8 is removed by etching, at a position corresponding to the modified part 8, a processed end surface 13c of an inner circular glass sheet 13 becomes an inclined surface in which a first main surface 13a side is located more inwardly than a second main surface 13b side. Similarly, at the position corresponding to the modified part 8, a processed end surface 14c of an outer glass sheet 14 (portion excluding the inner circular glass sheet 13) becomes an inclined surface in which a first main surface 14a side is located more outwardly than a second main surface 14b side. An inclination angle θ of each of the processed end surfaces 13c and 14c is, for example, from 75° to 89°. The inclination angle θ can be closer to 90° by adjusting the etching method in the etching step S3.

### (Adhesive Strength Weakening Step)

The adhesive strength weakening step S4 is performed on the laminate 1 in the state of comprising the glass sheet 2 and the adhesive film 3. In the adhesive strength weakening step S4, predetermined treatment is performed to weaken adhesive strength between the adhesive film 3 and the glass sheet 2 (the inner glass sheet 13 and the outer glass sheet 14) from which the modified part 8 is removed.

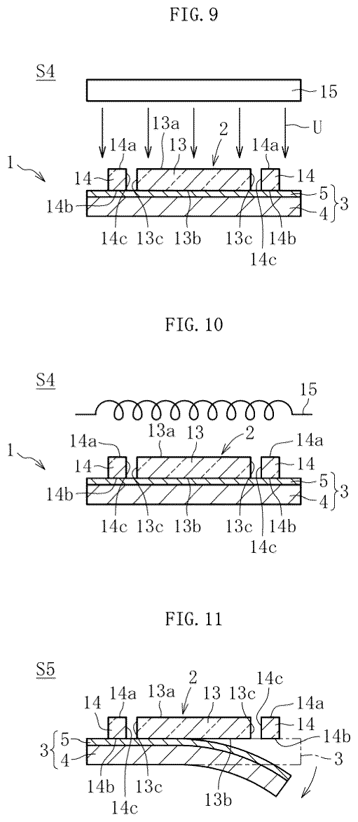

In a case of the ultraviolet curable resin or thermosetting resin, the adhesive strength decreases through curing of the resin. Accordingly, as illustrated in FIG. 9, when the adhesive layer 5 of the adhesive film 3 is the ultraviolet curable resin, in the adhesive strength weakening step S4, ultraviolet rays U are radiated from an ultraviolet ray irradiation device 15 onto the adhesive layer 5 in the state of the laminate 1, thereby curing the adhesive layer 5. Further, as illustrated in FIG. 10, when the adhesive layer 5 of the adhesive film 3 is the thermosetting resin, in the adhesive strength weakening step S4, the adhesive layer 5 in the state of the laminate 1 is heated with a heater 16, thereby curing the adhesive layer 5. When the adhesive film 3 is a self-adhesive film, the adhesive strength weakening step S4 may not be provided.

### (Peeling Step)

As illustrated in FIG. 11, in the peeling step S5, the adhesive film 3, whose adhesive strength has been weakened, is bent and peeled off from the glass sheet 2. Thus, the circular glass sheet 13 can be collected from the rectangular glass sheet 2. At this time, when the protruding portion 3b of the adhesive film 3 is pinched and peeled off, the peeling work can be carried out smoothly while preventing breakage of the glass sheet 2.

### (Glass Sheet)

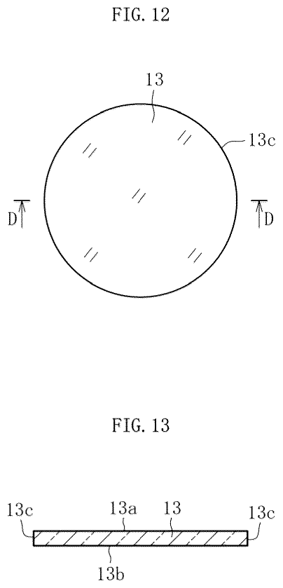

As illustrated in FIG. 12 and FIG. 13, the glass sheet (inner glass sheet) 13 obtained through the above-mentioned processing step S is circular in plan view.

The first main surface 13a and the end surface 13c of the glass sheet 13 are etched surfaces resulting from the etching step S3. The end surface 13c is, for example, an inclined surface in which the first main surface 13a side is located more inwardly than the second main surface 13b side (see the end surface 13c in FIG. 8).

The second main surface 13b of the glass sheet 13 is not etched in the etching step S3 and maintains its original surface characteristics. In other words, in this embodiment, the second main surface 13b is a fire-polished surface resulting from the overflow down-draw method. The surface roughness Ra of the second main surface 13b is 0.2 nm or less.

The thickness of the glass sheet 13 is 1 μm or more and 100 μm or less.

For example, the glass sheet 13 can be suitably used as a cover glass for a sensor or a cover glass for a hollow optical fiber.

The present invention is not limited to the configurations of the above-mentioned embodiment. In addition, the actions and effects of the present invention are not limited to those described above. The present invention may be modified in various forms within the range not departing from the spirit of the present invention.

While the case in which the circular glass sheet is cut out from the rectangular original glass sheet in the processing step has been given as an example in the above-mentioned embodiment, the shape of the original glass sheet and/or the shape of the glass sheet to be cut out are not limited to this. For example, the shape of the glass sheet to be cut out can be any shape, such as an oval, a rectangle, a polygon, or a cross. In particular, the manufacturing method of the present invention is useful when an outline shape of the glass sheet to be cut out has a curved line or a recessed bending portion.

While the case in which the circular glass sheet is cut out from the rectangular glass sheet in the processing step has been given as an example in the above-mentioned embodiment, the processing type is not limited to this. For example, a through hole may be formed in the glass sheet in the processing step. In this case, a modified part is formed in a preset processing part for the through hole with laser light. A plurality of through holes may be formed in a single glass sheet.

While the case in which etching is performed by immersing the glass sheet in the etchant in the etching step has been given as an example in the above-mentioned embodiment, the present invention is not limited to this. For example, etching may be performed by applying or jetting the etchant onto the first main surface of the glass sheet.

### EXAMPLES

The present invention is described in detail below by way of Examples, but the present invention is not limited to these Examples.

Rigidity of an adhesive film, peelability (ease of peeling) of a glass sheet, chemical resistance, handleability, and warping during processing were evaluated for different types of adhesive films. The results are shown in Table 1. In Table 1, “∘” indicates a result that is better than “Δ”.

TABLE 1

| | | No. 1 | No. 2 | No. 3 | No. 4 |
|---|---|---|---|---|---|
| Adhesion type | | Self- | Thermosetting | Ultraviolet | Ultraviolet |
| | | adhesive | (thermally | curable | curable |
| | | | foamable) | | |
| Adhesive | Before | 0.03 | 4.3 | 9.5 | 0.94 |
| strength | treatment | | | | |
| [N/20 mm] | After | — | 0.06 | 0.1 | 0.03 |
| | treatment | | | | |

| | | | | |
|---|---|---|---|---|
| Material of base | Polyolefin- | Polyester- | Polyolefin- | Polyolefin- |
| material | based | based | based | based |
| Material of adhesive | Polyethylene- | Unknown | Acrylic- | Acrylic- |
| layer | based | | based | based |
| Thickness of base material [μm] | — | 38 | 115 | 80 |
| Thickness of adhesive layer [μm] | — | 48 | 20 | 5 |
| Total thickness [μm] | 30 | 86 | 135 | 85 |
| Rigidity | Δ | ∘ | ∘ | ∘ |
| Peelability of glass | ∘ | Δ | Δ | ∘ |
| sheet | | | | |
| Chemical resistance | Δ | ∘ | ∘ | ∘ |
| (prevention of penetration of | | | | |
| etchant) | | | | |
| Handleability | ∘ | ∘ | ∘ | ∘ |
| Warping during | ∘ | ∘ | ∘ | ∘ |
| processing | | | | |

According to Table 1, when a laminate is provided by bonding an adhesive film such as Sample No. 1, 2, 3, or 4 to a glass sheet, handleability during processing is improved, and warping during processing can be suppressed.

According to Table 1, it is found that, as in Sample Nos. 1, 3, and 4, it is preferred that the base material be polyolefin-based and the adhesive layer be acrylic-based or polyethylene-based. In this case, while appropriate rigidity is imparted to the laminate comprising the glass sheet and the adhesive film in the modification step and the etching step, the adhesive film is easily peeled off from the glass sheet by bending the adhesive film in the peeling step. When the base material is polyester-based as in Sample No. 2, the rigidity of the adhesive film becomes too high, which tends to make it difficult to peel off the adhesive film from the glass sheet by bending the adhesive film in the peeling step.

According to Table 1, it is found that, as in Sample Nos. 2, 3, and 4, it is preferred that the total thickness of the adhesive film be 50 μm or more and 200 μm or less. In this case, while appropriate rigidity is imparted to the laminate comprising the glass sheet and the adhesive film in the modification step and the etching step, the adhesive film is easily peeled off from the glass sheet by bending the adhesive film in the peeling step. When the total thickness of the adhesive film is smaller than 50 μm as in Sample No. 1, the rigidity of the adhesive film becomes too low, which tends to make it difficult to impart appropriate rigidity to the laminate comprising the glass sheet and the adhesive film in the modification step and the etching step.

According to Table 1, it is found that, as in Sample No. 4, it is preferred that the adhesive strength of the adhesive film before the treatment to weaken the adhesive strength be 0.5 N/20 mm or more, and the adhesive strength of the adhesive film after the treatment to weaken the adhesive strength be 0.05 N/20 mm or less. In other words, when the adhesive strength before the treatment to weaken the adhesive strength is 0.5 N/20 mm or more, the glass sheet can be reliably fixed to the adhesive film in the modification step and the etching step. Accordingly, for example, in the etching step, penetration of the etchant between the glass sheet and the adhesive film can be reliably prevented. Meanwhile, when the adhesive strength of the adhesive film after the treatment to weaken the adhesive strength is 0.5 N/20 mm or more, it becomes easier to peel off the adhesive film from the glass sheet in the peeling step. When the adhesive film is a self-adhesive film as in Sample No. 1, the adhesive strength is extremely weak, and there is a risk in that the etchant penetrates between the glass sheet and the adhesive film in the etching step.

### REFERENCE SIGNS LIST

1 laminate
2 glass sheet
2a first main surface
2b second main surface
2c end surface
3 adhesive film
3a overlapping portion
3b protruding portion
4 base material
5 adhesive layer
6 laser device
7 preset processing part
8 modified part
9 suction-adhesion table
9a suction hole
10 support member
11 etching bath
12 etchant
13 inner glass sheet
13a first main surface
13b second main surface
13c processed end surface
14 outer glass sheet
14a first main surface
14b second main surface
14c processed end surface
15 ultraviolet ray irradiation device
16 heater
L laser light
U ultraviolet ray
S processing step
S1 bonding step
S2 modification step
S3 etching step
S4 adhesive strength weakening step
S5 peeling step

1. A method of manufacturing a glass sheet, the method comprising a processing step of processing the glass sheet,
the processing step comprising:
a bonding step of bonding an adhesive film to one of main surfaces of the glass sheet to form a laminate;
a modification step of forming a modified part in a preset processing part of the glass sheet in a state of the laminate by irradiation on the preset processing part with laser light after the bonding step;
an etching step of etching the modified part of the glass sheet in the state of the laminate after the modification step; and
a peeling step of peeling off the adhesive film from the glass sheet after the etching step.

2. The method of manufacturing a glass sheet according to claim 1, wherein a thickness of the glass sheet in the bonding step is 1 μm or more and 100 μm or less.

3. The method of manufacturing a glass sheet according to claim 1, wherein the laser light is ultrashort pulse laser light.

4. The method of manufacturing a glass sheet according to claim 1, wherein the laminate is immersed in an etchant in the etching step.

5. The method of manufacturing a glass sheet according to claim 1, wherein the adhesive film comprises a polyolefin-based base material, and an acrylic-based or polyethylene-based adhesive layer formed on one surface of the base material.

6. The method of manufacturing a glass sheet according to claim 1, wherein a thickness of the adhesive film is 50 μm or more and 200 μm or less.

7. The method of manufacturing a glass sheet according to claim 1, further comprising an adhesive strength weakening step of weakening adhesive strength of the adhesive film after the etching step and before the peeling step.

8. The method of manufacturing a glass sheet according to claim 7, wherein the adhesive film has an adhesive strength of 0.5 N/20 mm or more before the adhesive strength weakening step, and an adhesive strength of 0.05 N/20 mm or less after the adhesive strength weakening step.

9. The method of manufacturing a glass sheet according to claim 1, wherein the adhesive film is larger than the glass sheet.

10. A glass sheet, comprising:
a first main surface;
a second main surface; and
an end surface interposed between the first main surface and the second main surface,
wherein the first main surface and the end surface are etched surfaces,
wherein the second main surface is a fire-polished surface, and
wherein a thickness between the first main surface and the second main surface is 1 μm or more and 100 μm or less.

11. The glass sheet according to claim 10, wherein surface roughness (Ra) of the second main surface is 0.2 nm or less.

12. The glass sheet according to claim 10, wherein the glass sheet is a cover glass for a sensor or a cover glass for a hollow optical fiber.
